(19) United States
(12) Patent Application Publication
(10) Pub. No.: US 2002/0160081 A1
(43) Pub. Date: Oct. 31, 2002

(54) Nutritional product with high protein, low carbohydrate content and good physical stability

(76) Inventors: John Tiano, Venetia, PA (US); Jeffrey Wayne Liebrecht, Columbus, OH (US)

Correspondence Address: Donald O. Nickey, 8765 Colvin Drive, Plain City, OH, 43064, US

(21) Appl. No.: 09/809,738

(22) Filed: Mar. 14, 2001

(51) Int. Cl. A23L 1/30

(52) U.S. Cl. 426/72

(57) ABSTRACT

The present invention relates to the development of a good tasting and physically stable, ready to drink (RTD) nutritional product comprising high protein and low carbohydrates that would be useful as a nutritional supplement for people on the Atkins weight loss diet.

### FIELD OF THE INVENTION

The invention relates a ready to drink enteral nutritional product, more particularly, to a ready to drink enteral nutritional product comprising of fat, a high protein content and low carbohydrate content that is useful as a nutritional supplement for people on the Atkins, Sugar Busters, or other high protein, low carbohydrate weight loss diets and programs.

### BACKGROUND OF THE INVENTION

The diet and nutrition plan developed by Dr. Robert Atkins and others has existed in different versions since the early 1960s. It is also known as a “ketogenic diet” wherein restricted consumption of carbohydrates with an unlimited quantity of protein is promoted. The diet is also combined with specific nutritional supplements.

Ketosis, the principal behind the Atkins diet, means excess stored body fat is burned, resulting in weight loss. Rather than restrict consumption of additional fat or calories, the diet advocates restricting carbohydrates so that additional glucose or sugars are not added to the body's metabolism. It is believed that irregular insulin production converts excess carbohydrates into body fat. Calories that the human body requires are burned through benign dietary ketosis, or the burning of stored fat rather than from carbohydrates consumed.

The Atkins diet varies significantly from the recommended diets of the American Heart Association and the National Institute of Health. Individuals who use the Atkins diet must monitor carbohydrate intake for at least two weeks while consuming high protein meals and snacks. This helps determine the level of carbohydrates conductive to weight loss. According to Dr. Atkins, the carbohydrate ceiling for weight loss may be as high as 60 grams of carbohydrates per day or as low as 15 grams of carbohydrates per day, depending on the individual. Patients utilizing the Atkins diet have found that after they have achieved weight loss goals by restricting their carbohydrate intake, they are able to adopt a maintenance regimen by slightly increasing their carbohydrates. This level is generally between 30 and 90 grams of carbohydrates per day.

One aspect of the present invention relates to the development of a good tasting and physically stable liquid or a ready to drink (RTD) nutritional product that follows the Atkins diet. Challenges in producing such a RTD enteral formula include finding substitutes for simple sugars to make the product taste good, using a blend of proteins that do not cause processing viscosity or shelf life stability issues at the high per serving levels desired, and the desire to have a chocolate formula as cocoa brings in a significant amount of carbohydrates.

In one embodiment, the RTD nutritional product according to the invention derives about 42% of its calories from fat and about 58% of calories from protein. The product utilizes a specific mixture of vegetable oils and soy protein isolates in combination with calcium caseinate or milk protein islolates to achieve a nutritional supplement with good shelf life, physical stability, mouthfeel and taste. The inventive product also contains vitamins, trace and ultra trace minerals and flavors.

### BACKGROUND ART

U.S. Pat. No. 4,920,098 to Cotter et al. discloses a nutritional product for support or therapy of individuals at risk of atherosclerotic, cardiovascular and/or thrombotic diseases. The protein source, such as lactalbumin, comprises approximately 15 to about 25% of the caloric source for the Cotter enteral nutritional composition. The carbohydrate source comprises approximately 40% to approximately 75% of the caloric source of the Cotter enteral nutritional composition while the lipid component comprises approximately 10 to about 40%. This product would not confront the problems of physical stability and taste because of the high levels of carbohydrates and rather moderate levels of protein.

U.S. Pat. No. 5,340,603 to Neylan et al. relates to a hypercaloric formula providing nutritional support for human infants having chronic lung disease. The formula has a caloric density of at least 800 kcalories per liter of formula and wherein no less than 56% of the total calories is derived from fat; not more than 15% of total calories is derived from a high quality protein source; and from about 20 to about 27% of total calories is from a carbohydrate source. The Neylan et al. formula preferably has 67% of calories provided by fat; a reduced amount of sodium; slightly elevated levels of vitamins A, E and potassium, chloride, selenium, zinc, manganese and copper; appropriate levels of calcium and phosphorous; increased inositol levels; and appropriate levels of iron. The protein source is disclosed as being non-fat milk and whey protein concentrate. The fat source is disclosed as being fractionated coconut oil (medium chain triglycerides), soy oil and coconut oil. This reference does not suggest a RTD nutritional product having 3 grams or less of a carbohydrate per serving, about 20 grams of protein per serving, and 50 to 100% of the RDI of calcium. Further, this reference does not suggest the inclusion of soy protein or how to overcome the negative effects of its flavor profile. Lastly, concerns in processing viscosity and shelf life stability are not addressed in this reference.

U.S. Pat. No. 5,308,832 to Garleb et al. relates to a nutritional product for persons having neurological injury. The enteral nutritional product of Garleb et al. comprises a lipid blend having a ratio of n-6 to n-3 fatty acids in the range of 1:6; about 15 to 30% of the calories being provided by protein; about 70-85% of the calories being provided by fat; and less than 5% of the calories provided by carbohydrate. This reference does not suggest nor disclose a RTD nutritional product comprising a mixture of corn oil, high oleic sunflower oil and canola oil wherein the protein source is supplied by a blend of soy protein isolate and calcium caseinate.

U.S. Pat. No. 5,776,887 to Wibert et al. discloses a nutritional composition for the dietary management of diabetes comprising: (a) a protein component of 1 to 50% of total caloric value; (b) a fat component comprising 0 to 45% of total calories, (c) a carbohydrate component comprising 5 to 90% of total caloric value, wherein the carbohydrate component comprises i) a rapidly absorbed fraction comprising glucose; ii) a moderately absorbed fraction comprising one or more moderately absorbed monosaccharides, disaccharides and mixtures thereof; iii) a slowly absorbed fraction comprising one or more slowly absorbed glucose-containing polysaccharides and iv) fiber. This reference is not particularly relevant to the present invention but does provide a good discussion of how the carbohydrate component can be modified to adjust or regulate insulin production.

U.S. Pat. No. 5,817,695 to Pellico discloses a nutritional product with high fat, low carbohydrates and an amino acid imbalance. The nutritional product of this patent comprises: a) a carbohydrate source in an amount from 2 to about 15% of the per day total caloric requirement; b) fat in an amount of from about 40 to 80% of the per day caloric requirement; and c) a protein component defined by an amino acid profile that includes special levels of phenylalanine, tyrosine, methionine and other amino acids. This patent does not address the processing, mouthfeel and flavor problems associated with the preparation of a low carbohydrate and high protein RTD nutritional product.

### SUMMARY OF THE INVENTION

The RTD nutritional product of the present invention is not a no-carbohydrate nutritional. It is however, a nutritional product that focuses on very limited consumption of the types of carbohydrates that tend to spike blood sugar levels the most, including refined sugar products, juices and high sugar/starch fruit and vegetable components. The nutritional product according to the present invention is useful for an individual in determining their personal sensitivity to carbohydrates through allowing the dieter a convenient ready to drink formulation that contains essentially no carbohydrates. This will assist the dieter in managing their weight and health for life.

While there are numerous bars, nutritional supplements in capsule form, powdered drinks and the like available to the consumer, a RTD nutritional product useful in the Atkins diet has not seen commercial success because of problems associated with product stability, mouthfeel and taste. The unique combination of products in this invention results in a RTD that is both pleasing to the taste and physically stable over long periods of storage.

Consuming three servings of the inventive nutritional product will provide no more than 0 to 9 grams daily of carbohydrates and includes recommended nutritional supplements, a multi-vitamin formula and a safe and nutritional blend of lipids with the recommended n-3 to n-6 fatty acid ratio. A key reason for the greater success of nutritional products in accordance with the present invention over low fat diets and nutritional supplements is that users of the inventive RTD are significantly more satiated with the use of this product compared to the presently available low fat RTDs. The use of the inventive nutritional supplement enables users to lose weight easier, minimizing hunger side effects, reducing cravings for “cheat” foods, enabling users to maintain constant energy levels and to get a good night's rest.

Every serving of the inventive RTD provides from 25-100% of 27 essential vitamins and minerals plus around 20 grams of high quality protein and a healthy blend of fats.

Thus, there is disclosed a RTD nutritional product comprising a) from about 37 to 47% of calories from fat wherein said fat is a mixture of corn oil, sunflower oil, and canola oil; b) from about 53 to 62% of calories from protein wherein said protein is derived from a mixture of soy protein and caseinates or milk protein isolates c) from about 83 to 93% by weight water; d) vitamins; e) trace minerals; f) ultra trace minerals; and g) flavors.

### DETAILED DESCRIPTION OF THE INVENTION

Fat is generally present in the nutritional product in an amount from about 37 to 47% of the calories of the nutritional product. Preferably, the fat content ranges from 39 to 45% of calories and most preferably about 42% of calories. However, the American Heart Association's recommendations for total fat intake are 30% or less of total kilocalories. The fat blend and level in three servings of the ready-to-drink nutritional product herein would meet the current AHA guidelines; providing 3 grams of saturated fat, 7.5 grams of polyunsaturated fats and 13.5 grams of monounsaturated fats. The fat blend also provides a good mixture of omega-3 and omega-6 fatty acids. These fatty acids cannot be manufactured by the body and are known to be beneficial in the correct ratio. Current recommendations for essential fatty acids suggest a minimum of 3% of calories from omega-6 fats, including 60 calories from linoleic acid and a minimum of 0.5% of calories from omega-3 fats, with 10 calories from alpha-linolenic acid. Three servings of the inventive product would meet these dietary recommendations. The fat component may be any lipid or fat known in the art to be suitable for use in ready to drink nutritional compositions. Typical sources of fat include milk fat, safflower oil, canola oil, egg yolk lipid, olive oil, cotton seed oil, coconut oil, palm oil, palm kernel oil, soy bean oil, sunflower oil, fish oil and fractions of all the above oils derived thereof such as palm olein, medium chain triglycerides (MCT) and esters of fatty acids wherein the fatty acids are, for example, arachidonic acid, linoleic acid, palmitic acid, stearic acid, docosahexanoic acid, eicosapenaenoic acid, linoleic acid, oleic acid, lauric acid, capric acid, caprylic acid, caproic acid, and the like. High oleic forms of various oils are also contemplated to be useful herein such as high oleic sunflower oil and high oleic safflower oil.

The protein component is present in an amount, for example, of from about 53 to 62% of total calories, preferably from about 56 to 59% of total calories and more preferably about 58% of calories. The protein can be any protein, hydrolyzed protein and/or amino acid mixture known in the art to be suitable for use in RTD nutritional compositions. Typical proteins are animal proteins, vegetable proteins such as soy, wheat, pea and rice protein, milk proteins such as skim milk protein, whey protein and casein, and amino acids (or salts thereof). Preferred protein sources are soy protein and caseinates such as calcium caseinates and milk protein islolates. For some applications, a preferred protein source is hydrolyzed protein (protein hydrolosate) optionally supplemented with amino acids.

The nutritional compositions of the invention preferably contains vitamins and minerals. Vitamins and minerals are understood to be essential in the daily diet and these should be present in the nutritional product. Those skilled in the art appreciate that minimum requirements have been established for certain vitamins and minerals that are known to be necessary for normal, physiological functions. Practitioners also understand that appropriate additional amounts (overages) of vitamin and mineral ingredients need to be provided to nutritional compositions to compensate for some loss during processing and storage of such compositions. The composition of the present invention preferably contains nutritionally significant amounts of vitamins and minerals. It is preferred that the composition contain at least 100% of the US Recommended Daily Allowance (RDA) in 500 to 4000 calories of composition, more preferably 25% of the RDA in 180 calories of the nutritional composition. Selection of a specific vitamin or mineral compound to be used in the composition requires consideration of that compounds chemical nature regarding compatibility with the processing and its impact on shelf storage.

Examples of minerals, vitamins and other nutrients optionally present in the composition of the invention include vitamin A, vitamin B6, vitamin B12, vitamin E, vitamin K, vitamin C, vitamin D, inositol, taurine, folic acid, thiamin, riboflavin, niacin, biotin, pantothenic acid, choline, calcium, phosphorous, iodine, iron, magnesium, copper, zinc, manganese, chloride, potassium, sodium, beta carotene, nucleotides, selenium, chromium, molybdenum, and L-carnitine. Minerals are usually added in salt form. In addition to compatibility and stability considerations, the presence and amounts of specific minerals and other vitamins may vary somewhat depending on their impact to the physical stability and taste of the composition.

The composition of the invention also typically contains emulsifiers and/or stabilizers such as lecithin (e.g., oleic or soy), modified lecithins (e.g., enzyme or acetylated), carrageenan, xanthan gum, mono- and di-glycerides, guar gum, carboxymethylcellulose, or any mixture thereof

The composition of the invention may also contain one or more natural or artificial flavors to enhance palatability. Any flavor used in the art can be included provided a large carbohydrate component is not present in the flavor. Such flavors include strawberry, wild berry, banana, orange cream, cherry, chocolate, mocha, cappuccino, orange, vanilla, nutmeg, cinnamon, and the like.

The composition of the invention also optionally contains other miscellaneous ingredients that may contribute to the nutritional profile of the composition provide desirable palatability characteristics, such as enhanced flavor or mouthfeel.

The composition of the invention may also contain natural or artificial colors to enhance aesthetic appeal. The RTD composition of the invention also contains water. For example, the water content may vary from about 83 to 95 weight % of the total composition.

The composition of the invention can be prepared by use of standard techniques known in the nutritional arts. Protein and fat slurries are first made individually, the combined including the stabilizers and emulsifiers. The blend is pH modified and is then homogenized and pasteurized. Upon cooling, the product is standardized for protein, fat and the flavors, colors and vitamin premixes are added and the product is readied for sterilization.

The composition of the invention should be sterilized by techniques known in the art. For example, heat treatment such as autoclaving or retorting, irradiation or processed and packaged by aseptic technology. The composition of the invention can be packaged in any type of container or package known in the art to be useful for storing nutritional products such as aseptic paperboard, glass, plastic, coated metal cans and the like.

Preferably, the composition of the invention is nutritionally complete. By the term “nutritionally complete”, is meant that the composition contains adequate nutrients to sustain healthy human life for extended periods. The subjects consuming the composition of the invention are preferably humans, however, other mammals, especially primates, are also contemplated. The administration of the inventive composition is enteral (i.e., oral or tube feeding).

### Preferred Process for Preparing the RTD Product

### EXAMPLE 1

To prepare approximately 100 kg of the RTD composition according to the invention, the following materials were obtained:

| Components | Weight in Grams |
|---|---|
| Corn oil | 495 |
| HO sunflower oil | 660 |
| Canola oil | 981 |
| Lecithin | 171 |
| Soy protein isolate | 4669 |
| Calcium caseinate | 2701 |
| Water | 89129 |
| Potassium citrate | 376 |
| DMP —Magnesium Phosphate, Dibasic | 181 |
| Flavor (Vanilla, Chocolate) | Varies |
| Oil soluble Vitamin premix | 14.78 |
| Vitamin A palmitate | |
| Cholecalciferol (vitamin D₃) | |
| Vitamin E Acetate | |
| Phytonadione (vitamin K₁) | |
| Carrier (soybean oil) | |
| Water soluble trace/ultra trace mineral premix | 73.9 |
| Ascorbic acid | |
| Biotin | |
| d-calcium pantothenate | |
| Folic Acid | |
| Niacinamide | |
| Pyridoxine Hydrochloride | |
| Riboflavin | |
| Thiamine Mononitrate | |
| Cyanocobalamin | |
| Chromium Chloride | |
| Ferrous gluconate | |
| Manganese sulfate | |
| Sodium molybdate | |
| Potassium iodide | |
| Sodium selenite | |
| Zinc gluconate | |
| Copper gluconate | |
| Carrier (maltodextrin) | |
| Stabilizer | 30 |
| Acesulfame potassium | 11 |
| Sucralose | 33 |

The composition was prepared by preparing an oil blend by heating and mixing the HO sunflower, canola, corn, lecithin, stabilizer and OSV premix to about 110° F. About 90% of the water was heated to about 145° F., and the milk protein, the soy protein isolate, DMP and potassium citrate were then dissolved. The oil blend was added to the protein slurry and heated to 145° F. The pH was adjusted to within a range of 6.80 to 7.00. The slurry was then homogenized with 1000 psi pasteurized at 165° F. for 16 seconds, homogenized with 2500/400 and cooled. The product was standardized (fat, protein, TS) and was finished with the non-nutrative sweeteners, flavors and WSV premix. The pH was final adjusted to within a range of 6.80 to about 7.00, sterilized and hermetically sealed.

### Industrial Applicability

People on the Atkins diet are challenged in essentially eliminating carbohydrates from their diet. A diet that consists essentially of protein and fat is difficult to maintain. It would therefore be advantageous to the Atkins dieter to have a ready-to-drink nutritional product that assists them in achieving their goals. The present invention provides that assistance in a nutritionally complete, pleasant tasting product that is also physically stable over long periods of storage.

In the foregoing, there has been provided a detailed description of preferred embodiments of the present invention for the purpose of illustration and not limitation. It is to be understood that all other modifications, ramifications and equivalents obvious to those having skill in the art based on this disclosure are intended to be within the scope of the invention as claimed.

We claim:

1. A ready-to-drink nutritional product comprising:
a) from about 37 to 47% of calories from fat;
b) from about 53 to 62% of calories from protein;
c) less than 5% of calories from carbohydrates;
d) vitamins;
e) minerals; and
f) water.

2. The ready-to-drink nutritional product according to claim 1 wherein said fat comprises vegetable oil.

3. The ready-to-drink nutritional product according to claim 1 wherein said fat consists of corn oil, safflower or sunflower oil, canola oil and mixtures thereof.

4. The ready-to-drink nutritional product according to claim 1 wherein said fat is a mixture of corn oil, high oleic safflower or sunflower oil and canola oil.

5. The ready-to-drink nutritional product according to claim 1 wherein said protein is selected from the group consisting of soy protein, caseinates, milk protein islolates and mixtures thereof.

6. The ready-to-drink nutritional product according to claim 1 wherein said protein is a mixture of soy protein isolate and calcium caseinate.

7. The ready-to-drink nutritional product according to claim 1 additionally comprising potassium citrate and DMP.

8. A ready-to-drink nutritional product comprising by weight:
a) about 0.4 to about 0.6% corn oil;
b) about 0.5 to about 0.8% high oleic sunflower oil;
c) about 0.8 to about 1.1% canola oil;
d) about 0.1 to about 0.2% lecithin;
e) about 4.0 to about 6.0% soy protein isolate;
f) about 4.0 to about 6.0% calcium caseinate; and
g) about 83 to about 93% water.

9. The ready-to-drink nutritional product according to claim 8 additionally comprising potassium citrate and DMP.

10. The ready-to-drink nutritional product according to claim 8 additional comprising vitamins and minerals.
